(19) United States
(12) Patent Application Publication
(10) Pub. No.: US 2008/0222294 A1
(43) Pub. Date: Sep. 11, 2008

(54) Managing Communications Using a Mobile Device

(75) Inventor: Jie Liang, Plano, TX (US)

Correspondence Address: CHALKER FLORES, LLP, 2711 LBJ FRWY, Suite 1036, DALLAS, TX, 75234, US

(73) Assignee: PARAGON WIRELESS, INC., Richardson, TX (US)

(21) Appl. No.: 11/875,932

(22) Filed: Oct. 21, 2007

Related U.S. Application Data
(60) Provisional application No. 60/853,057, filed on Oct. 21, 2006.
(60) Provisional application No. 60/853,058, filed on Oct. 21, 2006.

(51) Int. Cl. G06F 15/16

(52) U.S. Cl. 709/227; 709/241

(57) ABSTRACT

A method and apparatus is provided for managing communications using a mobile device. More specifically, the present invention allows the mobile device to transfer a communication session from one network path to another network path. The user of the mobile device, therefore, has control over “network choice” instead of the network operators or handset providers. In addition, the present invention allows the mobile device to manage an association with one or more wireless network access points. With respect to access point management, the present invention provides a “fast scan” or “short scan” process to reduce the scanning time during active communication sessions to a level that is not detectable by the user. As a result, the present invention is more efficient, reduces power consumption, increases call quality and increases user acceptance of the device.

### PRIORITY CLAIM AND CROSS-REFERENCE TO RELATED APPLICATIONS

This patent application is a non-provisional application of the following U.S. provisional patent applications which are hereby incorporated by reference in their entirety: (1) application Ser. No. 60/853,057 filed on Oct. 21, 2006 and entitled “Method, Apparatus and System for Managing an Association with One or More Wireless Network Access Points”; and (2) application Ser. No. 60/853,058 filed on Oct. 21, 2006 and entitled “Method, Apparatus and System for Transferring a Communication Session from One Network Path to Another Network Path using a Dual Mode Mobile Device.”

### FIELD OF THE INVENTION

The present invention relates generally to the field of mobile communications and, more particularly, to a method and apparatus for managing communications using a mobile device.

### BACKGROUND OF THE INVENTION

Some mobile phones are capable of operating under multiple communications standards, such as digital and analog, multiple digital standards (e.g., CDMA and GSM), etc. Communication standards have also been developed to theoretically allow cellular phones to communicate with a traditional cellular network as well as an Unlicensed Mobile Access Network (UMAN). Currently, the decisions to use a particular network or transfer a communication session to another network are made for the most part by the networks, and more particularly the cellular networks. As a result, all of the potential advantages of “network choice” made possible by a dual mode device are not made available to the user.

Moreover, although establishing communication connections and sessions within a cellular network are virtually seamless to the end user, the short range and distributed nature of wireless IP-based networks require mobile devices, both single mode VoIP devices and dual mode devices, to periodically scan for available access points. These scans are conducted during active communication sessions and cause a noticeable reduction in call quality to the user. For example, a typical scan interrupts the active communication and will scan eleven to fourteen channels. A scan of one channel can take 200 ms. As a result, the complete scan can take two to three seconds to complete, which the user observes as a delay in the conversation or a cracking/popping noise. The user unknowingly believes that this event is a bad connection caused by the network rather than being caused by the user's device. One alternative is to perform the complete scan, but spread it out over time (i.e., pause the scan to allow ongoing communications). This alternative is still problematic in that it takes longer to obtain the required information and does not reduce power consumption. Accordingly, the user may not continue to use the VoIP communication device or may influence others not to use such devices because of his/her bad experience.

There is, therefore, a need for a method and apparatus for managing using a mobile device.

### SUMMARY OF THE INVENTION

The present invention provides a method and apparatus for managing communications using a mobile device. More specifically, the present invention allows the mobile device to transfer a communication session from one network path to another network path. The user of the mobile device, therefore, has control over “network choice” instead of the network operators or handset providers. In addition, the present invention allows the mobile device to manage an association with one or more wireless network access points. With respect to access point management, the present invention provides a “fast scan” or “short scan” process to reduce the scanning time during active communication sessions to a level that is not detectable by the user. As a result, the present invention is more efficient, reduces power consumption, increases call quality and increases user acceptance of the device.

For example, the present invention provides a method of monitoring one or more parameters associated with the first network path and the second network path using the mobile communications device, selecting one of the network paths based on one or more criteria and transferring the communication session to the selected network path whenever the communication session is not using the selected network path. The method can be implemented using a computer program embodied on a computer readable medium wherein each step is performed by one or more code segments.

In addition, the present invention provides a dual mode communications device that includes a VoIP module, a RF module and one or more applications communicably coupled to the VoIP module and the RF module. The application monitors one or more parameters associated with the first network path and the second network path, selects one of the network paths based on one or more criteria and transfers the communication session to the selected network path whenever the communication session is not using the selected network path.

Moreover, the present invention provides a method of managing an association with one or more wireless network access points. A signal from one of the access points is monitored and preparations are made to change to a new access point whenever one or more parameters of the signal fall below a first threshold. A change to the new access point is made whenever one or more parameters of the signal fall below a second threshold. In addition, a scan is periodically performed of the one or more access points wherein the scan comprises a short scan if a communication session is active and a complete scan otherwise. Note that the method can be implemented using a computer program embodied on a computer readable medium wherein each step is preformed by one or more code segments.

In addition, the present invention provides a communications device that includes a VoIP module and an application communicably coupled to the VoIP module. The application monitors a signal from one of the access points, prepares to change to a new access point whenever one or more parameters of the signal fall below a first threshold, changes to the new access point whenever one or more parameters of the signal fall below a second threshold, and periodically performs a scan of the one or more access points wherein the scan comprises a short scan if a communication session is active and a complete scan otherwise. The communications device may also include a RF module communicably coupled to the application.

The present invention also provides a method of managing an association with one or more wireless network access points by selecting a channel from a list of available channels that are sorted based on one or more criteria, scanning the selected channel and adjusting the list whenever the selected channel does not satisfy one or more parameters. Note that the method can be implemented using a computer program embodied on a computer readable medium wherein each step is preformed by one or more code segments.

Furthermore, the present invention provides a communications device that includes a VoIP module and an application communicably coupled to the VoIP module. The application selects a channel from a list of available channels that are sorted based on one or more criteria, scans the selected channel and adjusts the list whenever the selected channel does not satisfy the one or more parameters. The communications device may also include a RF module communicably coupled to the application.

The present invention is described in detail below with reference to the accompanying drawings.

### BRIEF DESCRIPTION OF THE DRAWINGS

The above and further advantages of the invention may be better understood by referring to the following description in conjunction with the accompanying drawings, in which:

FIG. 1 shows a block diagram depicting parts of a cellular network with an IP network in accordance with one embodiment of the present invention;

FIG. 2 shows a flow chart of a network path selection process in accordance with one embodiment of the present invention;

FIG. 3 shows a signaling diagram for transferring a communication session from a cellular network to an IP network in accordance with one embodiment of the present invention;

FIG. 4 shows a signaling diagram for transferring a communication session from an IP network to a cellular network in accordance with one embodiment of the present invention;

FIG. 5 shows a flow chart of a network path selection process for an incoming communication session in accordance with one embodiment of the present invention;

FIG. 6 shows a signaling diagram for transferring an incoming communication session from a cellular network to an IP network in accordance with one embodiment of the present invention;

FIG. 7 shows a signaling diagram for transferring an incoming communication session from an IP network to a cellular network in accordance with one embodiment of the present invention;

FIG. 8 shows a flow chart of a network path selection process for an outgoing communication session in accordance with one embodiment of the present invention;

FIG. 9 shows a flow chart of a network path selection process in accordance with another embodiment of the present invention;

FIG. 10 is a block diagram of a mobile communications device moving between areas covered by access points of a wireless network in accordance with the present invention;

FIG. 11 is a graph of signal strength versus time for changing a network path in accordance with one embodiment of the present invention;

FIG. 12 is a flow chart of a network path selection process in accordance with another embodiment of the present invention;

FIG. 13 is a block diagram of a mobile communications device moving between areas covered by access points of a wireless network in accordance with the present invention;

FIG. 14 is a graph of signal strength versus time for changing an association from one access point to another in accordance with one embodiment of the present invention;

FIG. 15 is a flow chart of a method of managing an association with one or more wireless access points in accordance with one embodiment of the present invention;

FIG. 16 is a flow chart of a method of performing a complete scan in accordance with one embodiment of the present invention; and

FIG. 17 is a flow chart of a method of performing a short scan in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

The present invention provides a method and apparatus for managing communications using a mobile device. More specifically, the present invention allows the mobile device to transfer a communication session from one network path to another network path. The user of the mobile device, therefore, has control over “network choice” instead of the network operators or handset providers. In addition, the present invention allows the mobile device to manage an association with one or more wireless network access points. With respect to access point management, the present invention provides a “fast scan” or “short scan” process to reduce the scanning time during active communication sessions to a level that is not detectable by the user. As a result, the present invention is more efficient, reduces power consumption, increases call quality and increases user acceptance of the device.

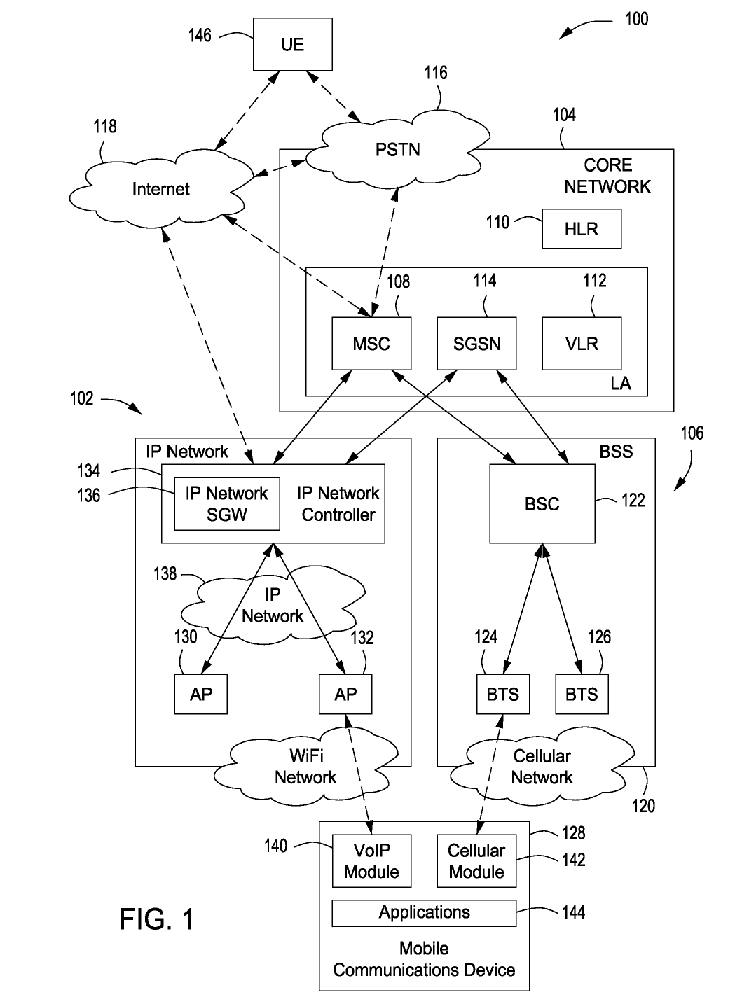

Referring now to FIG. 1, a block diagram depicting parts of a cellular network 100 with an IP network 102 in accordance with one embodiment of the present invention is shown. The cellular network 100 typically includes a core network portion 104 and an access portion 106. The elements of the core network 104 include the mobile switching center (MSC) 108, associated home location register (HLR) 110, visitor location register (VLR) 112 and other elements that are not shown. The function and structure of these conventional cellular architecture elements are known to those in the art and will not be described in further detail here. The core network 104 also supports the General Packet Radio Service (GPRS) using a serving GPRS support node (SGSN) 114. Although not illustrated in FIG. 1, it will be understood by those skilled in the art that the core network 104 may include access to other mobile and fixed-line networks, such as ISDN and PSTN networks 116, packet and circuit switched packet data networks such as intranets, extranets and the Internet 118 through one or more gateway nodes. The access portion 106 essentially consists of multiple base station subsystems (BSS) 120, which includes one or more base station controllers (BSC) 122 and one or more base transceiver stations (BTS) 124 and 126. The BSS 120 or BSC 122 communicates with the MSC 108 and SGSN 114 in the core network portion 104. The BTS 124 and 126 communicates with mobile devices 128, which are also referred to as mobile stations or terminals. The BSC 122 can be separate from the BTSs 124 and 126 and may even be located at the MSC 108.

The IP network 102 includes one or more APs 130 and 132 and one or more UNCs 134 (each having a Secure Gateway 136 (IP Network SGW)), interconnected through a broadband IP network 138. The IP Network SGW 136 terminates secure remote access tunnels from the mobile device 128 and provides mutual authentication, encryption and data integrity for signaling, voice and data traffic. Note that each IP Network Controller 134 can have multiple UNC SGWs, or a UNC SGW pool can serve multiple UNCs. The IP network 102 can be an unlicensed-radio access network (UMAN) or other radio protocol that does not require the operator running the mobile network to have obtained a license from the appropriate regulatory body. The IP network 102 also enables the mobile device 128 to access the core network 104. The access points (AP) 130 and 132 (also referred to as a local or home base station (HBS)) of the IP network 102 communicate across the unlicensed radio interface and handle the radio link protocols with mobile device 128. The access points 130 and 132 contain radio transceivers that define a cell in a similar manner to the operation of a conventional BTS 126 and 124. The APs 130 and 132 are controlled by an IP Network Controller 134 (also referred to as a unlicensed network controller (UNC) or home base station controller (HBSC)), which communicates with MSC 108 and SGSN 114. The joint function of the APs 130 and 132 and the IP Network Controller 134 emulates the operation of the BSS 120 towards the MSC 108 and SGSN 114. In other words, when viewed from the elements of the core network 104 such as the MSC 108 and the SGSN 114, the IP network 102 looks like a conventional access network 106.

The mobile device 128 provides dual mode (licensed and unlicensed) radios and the capability to switch between them. More specifically, the mobile device 128 includes a VoIP module 140, a cellular module 142 and one or more applications 144 communicably coupled to the VoIP module 140 and the cellular module 142. The application 144 monitors one or more parameters associated with the first network path and the second network path, selects one of the network paths based on one or more criteria and transfers the communication session to the selected network path whenever the communication session is not using the selected network path. The first network path can be the cellular network 100 and the second network path can be the IP network 102, or the first network path can be the IP network 102 and the second network path can be the cellular network 100, or both network paths can be different paths within the IP network 102, or both network paths can be different paths within the cellular network 100. As a result, the mobile device 128 can communicate with user equipment (UE) 146 using either the cellular network 100 or the IP network 102.

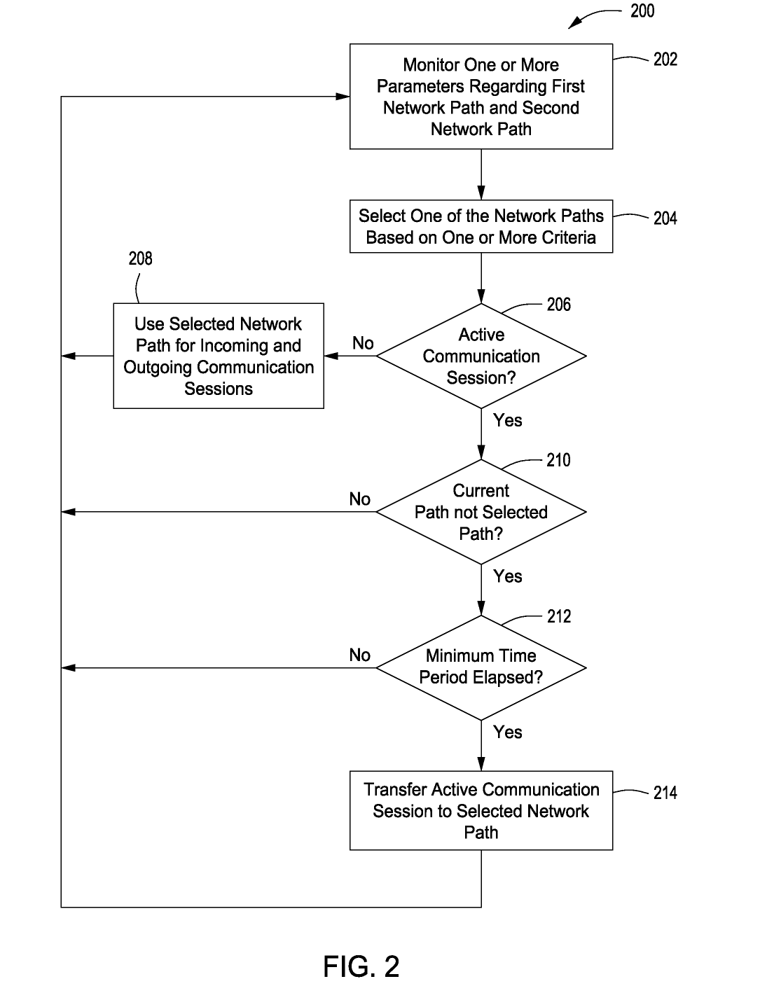

Now referring to FIG. 2, a flow chart of a network path selection process 200 in accordance with one embodiment of the present invention is shown. The process 200 begins by monitoring one or more parameters associated with the first network path and the second network path using the mobile communications device in block 202. For example, the first network path can be a cellular network and the second network path can be an IP network, or the first network path can be the IP network and the second network path can be the cellular network, or both network paths can be different paths within the IP network, or both network paths can be different paths within the cellular network. Note that the present invention is not limited only to IP and cellular networks, but can be adapted to work with any communication networks, such as a satellite network. The one or more parameters may include diagnostic information, operational information, performance information, location information, network information, network operator information, network path information, quality of service information, security information, signal strength, velocity, connection quality, voice quality, communications rate, packet loss, RF channel estimation, roaming speed or a combination thereof. One of the network paths is selected based on one or more criteria in block 204. The one or more criteria may include diagnostic information, operational information, performance information, location information, network information, network operator information, network path information, historical information, quality of service information, security information, communication session type, trigger events, user information or preferences, rate plans for the first and second network paths, estimated cost for the communication session, estimated costs for the transfer, minutes used, minutes available or a combination thereof. The trigger events may include the mobile communications device roaming between the first network path and the second network path, the communication session is dropped, successful association with an IP network, a user override, a drop in signal strength, communications rate or voice quality below a threshold value or a combination thereof.

If a communication session is not active, as determined in decision block 206, the selected network path is used for incoming and outgoing sessions in block 208 and the process returns to monitor the one or more parameters in block 202. Note that the selected network path for incoming communication sessions can be different from the selected path for outgoing communication sessions based on the one or more criteria. If, however, a communication session is active, as determined in decision block 206, and the current network path being used is the selected network path, as determined in decision block 210, the process returns to monitor the one or more parameters in block 202. If, however, the current network path being used is not the selected network path, as determined in decision block 210, and a minimum time period has not elapsed, as determined in decision block 212, the process returns to monitor the one or more parameters in block 202. The minimum time period can be since initiation of the communication session, a previous transfer or a combination thereof.

If, however, the minimum time period has elapsed, as determined in decision block 212, the communication session is transferred to the selected network path in block 214. Note that the communication session can be a new incoming communication session, a new outgoing communication session or an existing communication session. The communication session can be transferred by sending a transfer request via the first network path, the second network path or a combination thereof. Moreover, the communication session transfer can be a horizontal handover or a vertical handover. Preferably, the communication session is transferred without interruption, using a make-before-break process or transparently to a user of the communications device. Note that the communication session can be buffered during the transfer to the selected network path. The method can be implemented using a computer program embodied on a computer readable medium wherein each step is performed by one or more code segments.

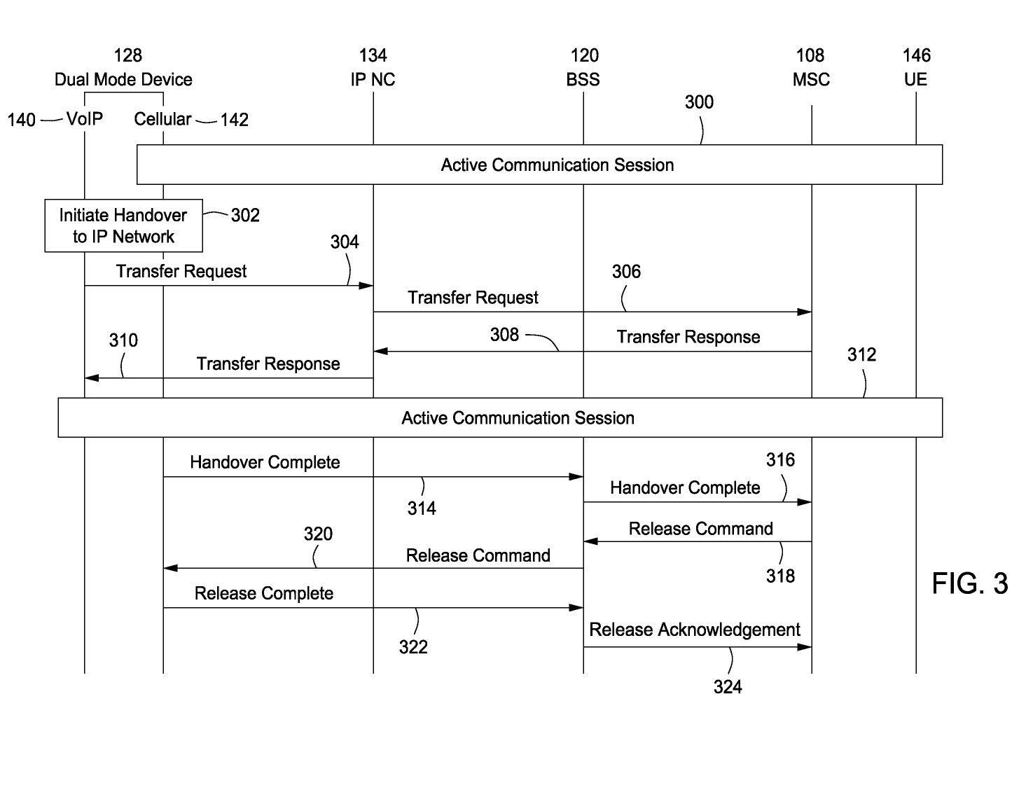

Referring now to FIG. 3, a signaling diagram for transferring a communication session from a cellular network to an IP network in accordance with one embodiment of the present invention is shown. The active communication session 300 is established between the cellular module 142 of the mobile device 128 and an end user 146. At some point during the communication session 300, the present invention determines that the communication session should be transferred and initiates the handover to the IP network 302. The VoIP module 140 of the mobile device 128 sends a transfer request message 304 to the IP Network Controller 134, which forwards the transfer request message 306 to the MSC 108. Alternatively, the transfer request message 304 can be sent to the MSC 108 via the cellular module 142 and BSS 120 instead of the VoIP module 140 and IP Network Controller 134. The MSC 108 sends a transfer response message 308 (e.g., approved, denied, etc.) to the IP Network Controller 134, which forwards the transfer response message 310 to the VoIP module 140 of the mobile device 128. The MSC 108 then reroutes the communication session 312 through the IP network. The mobile device 128 determines that the incoming communication session is the same as the active communication session based on caller identification information, a time widow associated with the transfer, or other information provided in the call set up process. For example, the network operators can provide the mobile device 128 with a handover number so that if a call is dropped, the mobile device 128 can call the handover number, which is recognized by the network operator, and the call is re-established (transferred) using the alternate network path. Once the communication session 312 is successfully established, the cellular module 142 of the mobile device 128 sends a handover complete message 314 to the BSS 120, which forwards the handover complete message 316 to the MSC 108. The MSC 108 then sends a release command message 318 to the BSS 120, which forwards the release command message 320 to the cellular module 142 of the mobile device 128. The cellular module 142 of the mobile device releases the call 300 and sends a release complete message 322 to the BSS 120, which sends a release acknowledgement message 324 to the MSC 108. Note that the current communication session 300 is maintained and/or buffered until it is released in response to the release command message 320. Alternatively, the handover complete message 314 can be sent to the MSC 108 via the VoIP module 140 and IP Network Controller 134 instead of the cellular module 142 and BSS 120.

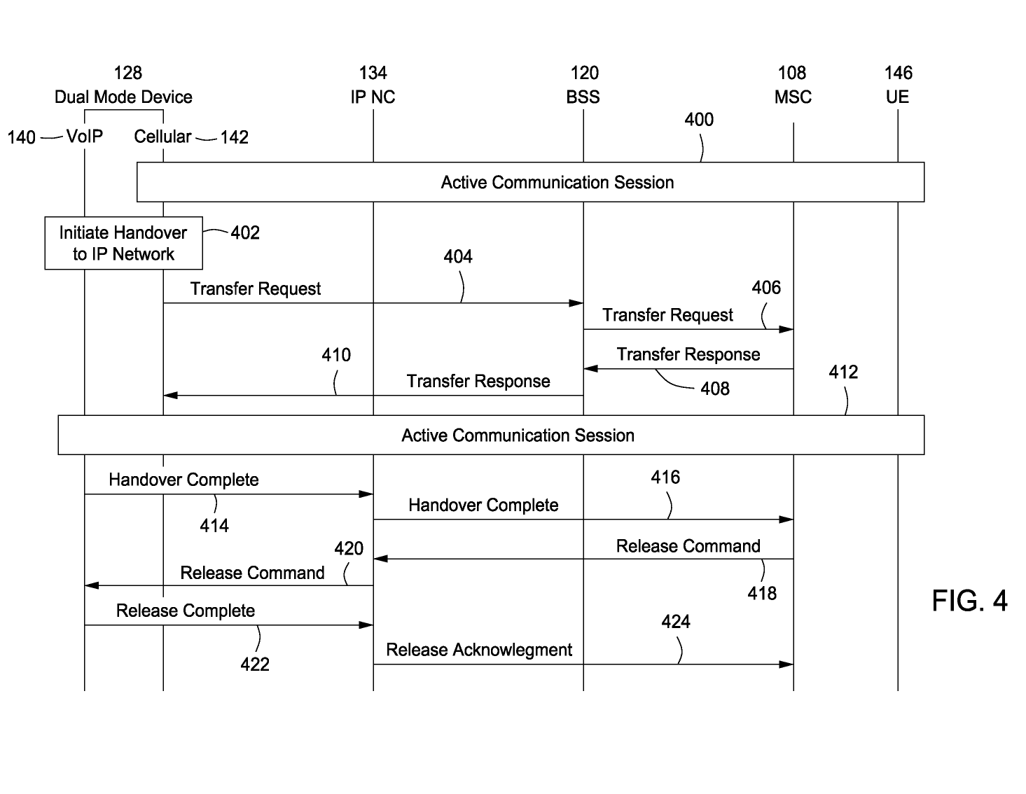

Now referring to FIG. 4, a signaling diagram for transferring a communication session from an IP network to a cellular network in accordance with one embodiment of the present invention is shown. The active communication session 400 is established between the VoIP module 140 of the mobile device 128 and an end user 146. At some point during the communication session 400, the present invention determines that the communication session should be transferred and initiates the handover to the cellular network 402. The cellular module 142 of the mobile device 128 sends a transfer request message 404 to the IP BSS 120, which forwards the transfer request message 406 to the MSC 108. Alternatively, the transfer request message 404 can be sent to the MSC 108 via the VoIP module 140 and IP Network Controller 134 instead of the cellular module 142 and BSS 120. The MSC 108 sends a transfer response message 408 (e.g., approved, denied, etc.) to the BSS 120, which forwards the transfer response message 410 to the cellular module 142 of the mobile device 128. The MSC 108 then reroutes the communication session 412 through the cellular network. The mobile device 128 determines that the incoming communication session is the same as the active communication session based on caller identification information, a time widow associated with the transfer, or other information provided in the call set up process. For example, the network operators can provide the mobile device 128 with a handover number so that if a call is dropped, the mobile device 128 can call the handover number, which is recognized by the network operator, and the call is re-established (transferred) using the alternate network path. Once the communication session 412 is successfully established, the VoIP module 140 of the mobile device 128 sends a handover complete message 414 to the IP Network Controller 134, which forwards the handover complete message 416 to the MSC 108. The MSC 108 then sends a release command message 418 to the IP Network Controller 134, which forwards the release command message 420 to the VoIP module 140 of the mobile device 128. The VoIP module 140 of the mobile device releases the call 400 and sends a release complete message 422 to the IP Network Controller 134, which sends a release acknowledgement message 424 to the MSC 108. Note that the current communication session 400 is maintained and/or buffered until it is released in response to the release command message 420. Alternatively, the handover complete message 414 can be sent to the MSC 108 via the cellular module 142 and BSS 120 instead of the VoIP module 140 and IP Network Controller 134.

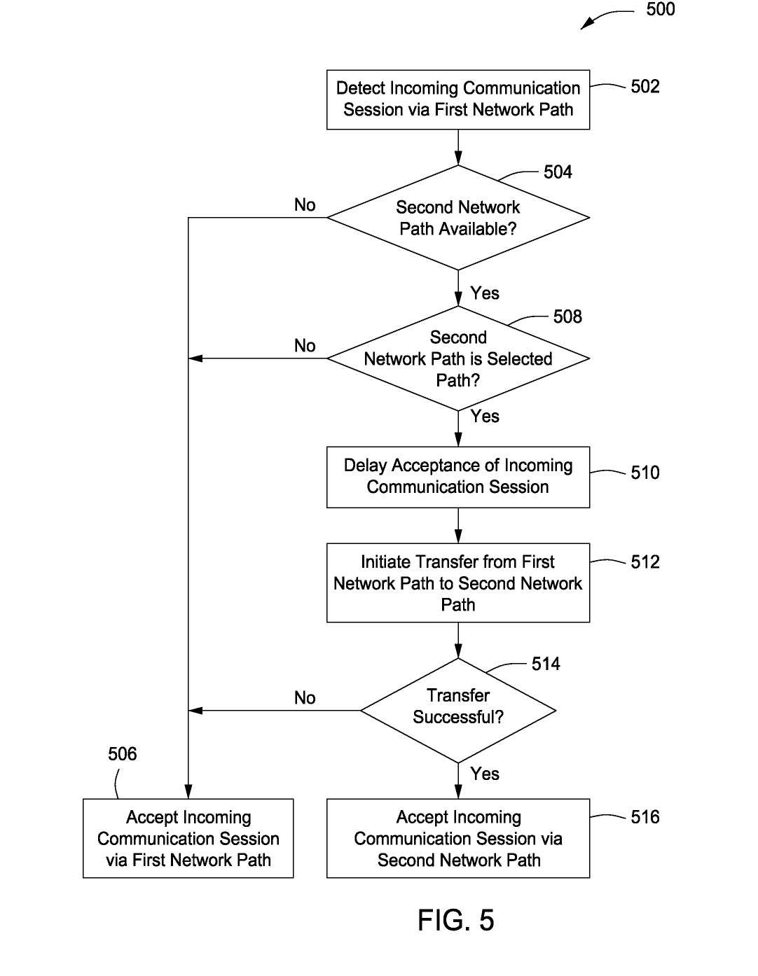

Referring now to FIG. 5, a flow chart of a network path selection process 500 for an incoming communication session in accordance with one embodiment of the present invention is shown. The mobile device detects an incoming communication session via a first network path in block 502. For example, the first network path can be a cellular network and the second network path can be an IP network, or the first network path can be the IP network and the second network path can be the cellular network, or both network paths can be different paths within the IP network, or both network paths can be different paths within the cellular network. Note that the present invention is not limited only to IP and cellular networks, but can be adapted to work with any communication networks, such as a satellite network. If the second network path is not available, as determined in decision block 504, the incoming communication is accepted via the first network path in block 506. If, however, the second network path is available, as determined in decision block 504, and the second network path is not the selected network (see FIG. 2), as determined in decision block 508, the incoming communication is accepted via the first network path in block 506. If, however, the second network path is the selected network, as determined in decision block 508, the acceptance of the incoming communication session is delayed in block 510 and a transfer from the first network path to the second network path is initiated in block 512. If, the transfer is not successful, as determined in decision block 514, the incoming communication is accepted via the first network path (non-selected network path) in block 506. If, however, the transfer is successful, as determined in decision block 514, the incoming communication is accepted via the second network path (selected network path) in block 516. The method can be implemented using a computer program embodied on a computer readable medium wherein each step is performed by one or more code segments.

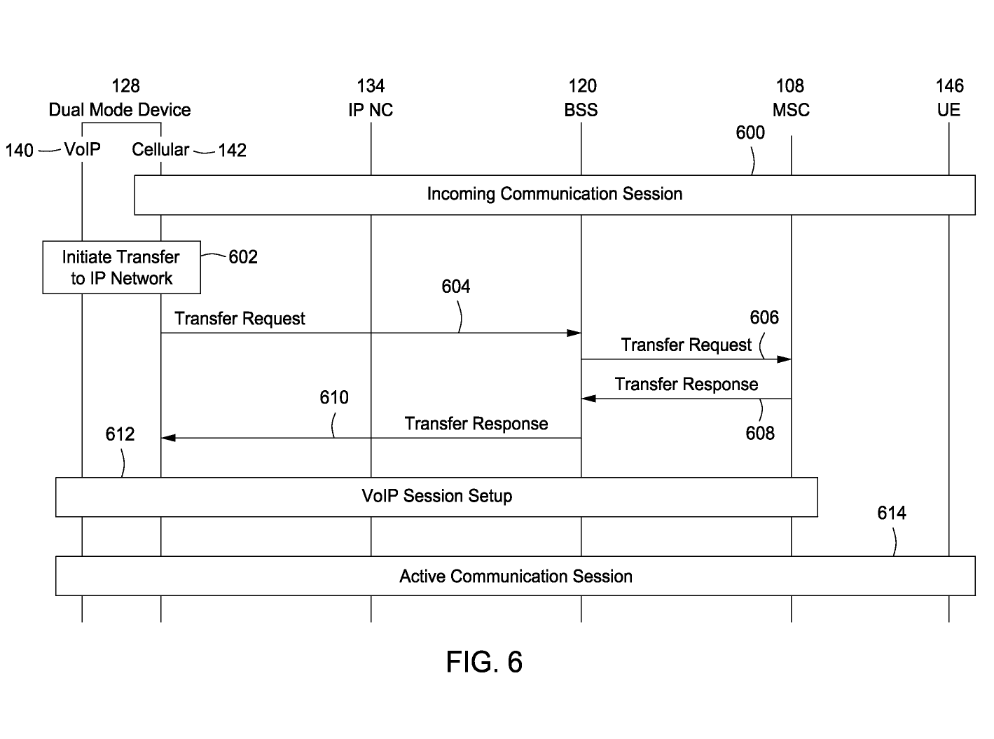

Now referring to FIG. 6, a signaling diagram for transferring an incoming communication session from a cellular network to an IP network in accordance with one embodiment of the present invention is shown. The cellular module 142 detects an incoming communication session 600 via the cellular network. The present invention determines that the communication session should be transferred and initiates the handover to the IP network 602. The cellular module 142 of the mobile device 128 sends a transfer request message 604 to the IP BSS 120, which forwards the transfer request message 606 to the MSC 108. Alternatively, the transfer request message 604 can be sent to the MSC 108 via the VoIP module 140 and IP Network Controller 134 instead of the cellular module 142 and BSS 120. The MSC 108 sends a transfer response message 608 (e.g., approved, denied, etc.) to the BSS 120, which forwards the transfer response message 610 to the cellular module 142 of the mobile device 128. The VoIP session setup process 612 is performed and the active communication session 614 is established with the end user 146 via the IP network. In other words, the MSC 108 reroutes the communication session 600 through the IP network. The mobile device 128 determines that the incoming communication session is the same as the active communication session based on caller identification information, a time widow associated with the transfer, or other information provided in the call set up process.

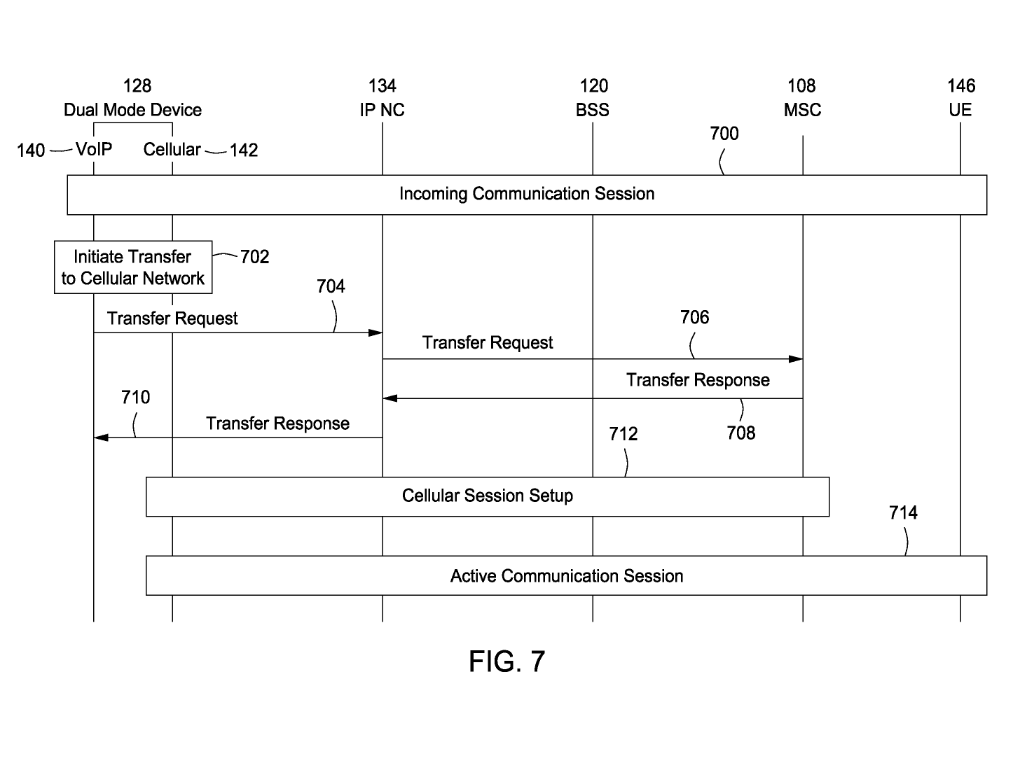

Referring now to FIG. 7, a signaling diagram for transferring an incoming communication session from an IP network to a cellular network in accordance with one embodiment of the present invention is shown. The VoIP module 140 detects an incoming communication session 700 via the cellular network. The present invention determines that the communication session should be transferred and initiates the handover to the cellular network 702. The VoIP module 140 of the mobile device 128 sends a transfer request message 704 to the Network Controller 134, which forwards the transfer request message 706 to the MSC 108. Alternatively, the transfer request message 704 can be sent to the MSC 108 via the cellular module 142 and BSS 120 instead of the VoIP module 140 and IP Network Controller 134. The MSC 108 sends a transfer response message 708 (e.g., approved, denied, etc.) to the IP Network Controller 134, which forwards the transfer response message 710 to the VoIP module 140 of the mobile device 128. The VoIP session setup process 712 is performed and the active communication session 714 is established with the end user 146 via the cellular network. In other words, the MSC 108 reroutes the communication session 700 through the cellular network. The mobile device 128 determines that the incoming communication session is the same as the active communication session based on caller identification information, a time widow associated with the transfer, or other information provided in the call set up process.

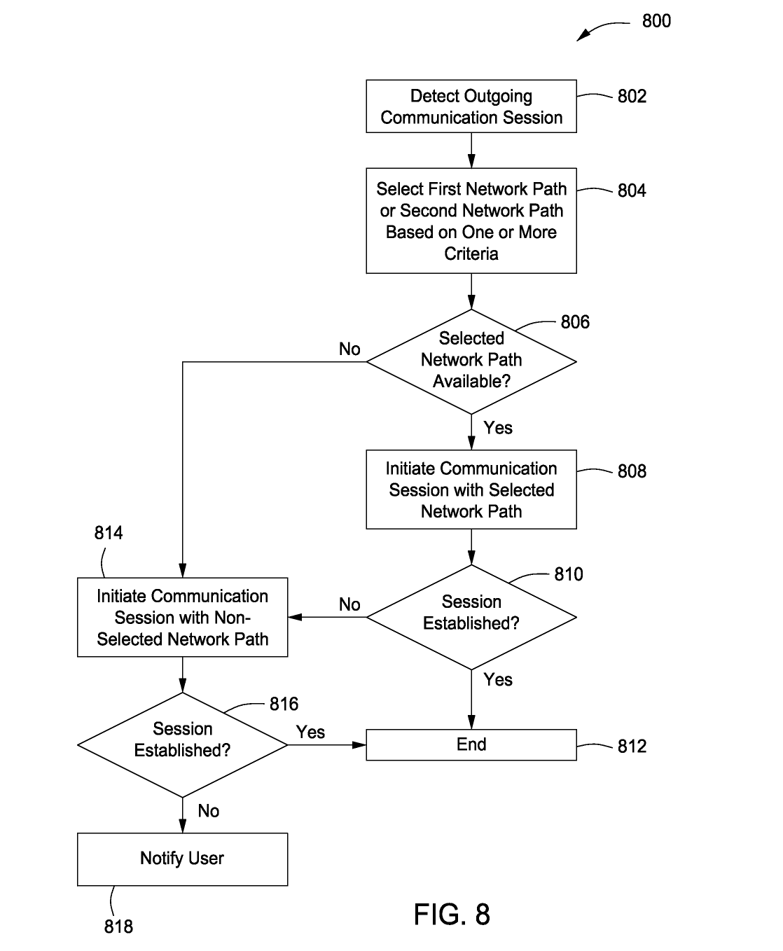

Now referring to FIG. 8, a flow chart of a network path selection process 800 for an outgoing communication session in accordance with one embodiment of the present invention is shown. The mobile device 128 detects an outgoing communication session in block 802 and selects a first network path or a second network path based on one or more criteria in block 804. For example, the first network path can be a cellular network and the second network path can be an IP network, or the first network path can be the IP network and the second network path can be the cellular network, or both network paths can be different paths within the IP network, or both network paths can be different paths within the cellular network. Note that the present invention is not limited only to IP and cellular networks, but can be adapted to work with any communication networks, such as a satellite network. If the selected network path is available, as determined in decision block 806, a communication session is initiated with the selected network path in block 808. If the communication session is successfully established, as determined in decision block 810, the process ends in block 812. If, however, the selected network path is not available, as determined in decision block 806, or the communication session with the selected network path is not successful, as determined in decision block 810, a communication session is initiated with the non-selected network path in block 814. If the communication session is successfully established, as determined in decision block 816, the process ends in block 812. If, however, the session is not successfully established, as determined in decision block 816, the user is notified that no networks are available in block 818. The method can be implemented using a computer program embodied on a computer readable medium wherein each step is performed by one or more code segments.

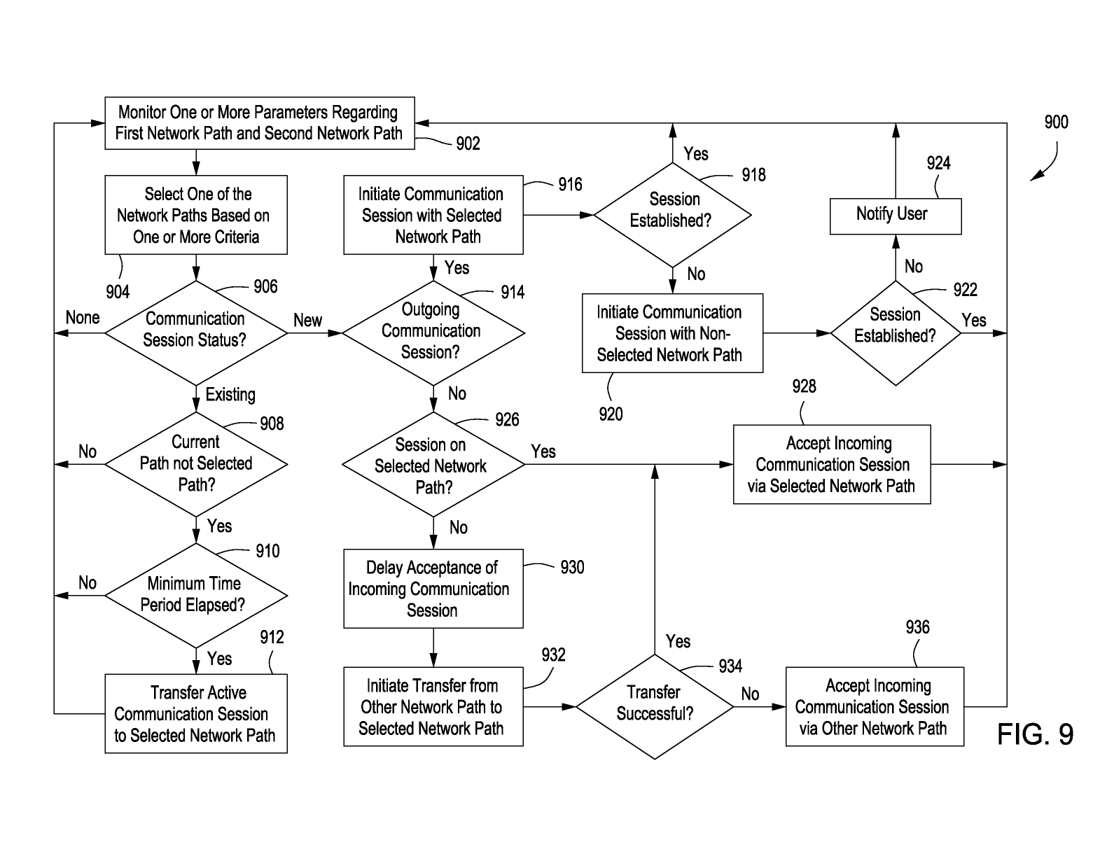

Now referring to FIG. 9, a flow chart of a network path selection process 900 in accordance with another embodiment of the present invention is shown. The process 900 begins by monitoring one or more parameters associated with the first network path and the second network path using the mobile communications device in block 902. For example, the first network path can be a cellular network and the second network path can be an IP network, or the first network path can be the IP network and the second network path can be the cellular network, or both network paths can be different paths within the IP network, or both network paths can be different paths within the cellular network. Note that the present invention is not limited only to IP and cellular networks, but can be adapted to work with any communication networks, such as a satellite network. The one or more parameters may include diagnostic information, operational information, performance information, location information, network information, network operator information, network path information, quality of service information, security information, signal strength, velocity, connection quality, voice quality, communications rate, packet loss, RF channel estimation, roaming speed or a combination thereof. One of the network paths is selected based on one or more criteria in block 904. The one or more criteria may include diagnostic information, operational information, performance information, location information, network information, network operator information, network path information, historical information, quality of service information, security information, communication session type, trigger events, user information or preferences, rate plans for the first and second network paths, estimated cost for the communication session, estimated costs for the transfer, minutes used, minutes available or a combination thereof. The trigger events may include the mobile communications device roaming between the first network path and the second network path, the communication session is dropped, successful association with an IP network, a user override, a drop in signal strength, communications rate or voice quality below a threshold value or a combination thereof.

If the communication session status in none (not active), as determined in decision block 906, the process returns to monitor the one or more parameters in block 902. If the communication session status is existing, as determined in decision block 906, and the current network path being used is the selected network path, as determined in decision block 908, the process returns to monitor the one or more parameters in block 902. If, however, the current network path being used is not the selected network path, as determined in decision block 908, and a minimum time period has not elapsed, as determined in decision block 910, the process returns to monitor the one or more parameters in block 902. The minimum time period can be since initiation of the communication session, a previous transfer or a combination thereof. If, however, the minimum time period has elapsed, as determined in decision block 910, the communication session is transferred to the selected network path. The communication session can be transferred by sending a transfer request via the first network path, the second network path or a combination thereof. Moreover, the communication session transfer can be a horizontal handover or a vertical handover. Preferably, the communication session is transferred without interruption, using a make-before-break process or transparently to a user of the communications device. Note that the communication session can be buffered during the transfer to the selected network path.

If the communication session status is new, as determined in decision block 906 and the communication session is outgoing, as determined in decision block 914, a communication session is initiated with the selected network path in block 916. If the communication session is successfully established, as determined in decision block 918, the process returns to monitor the one or more parameters in block 902. If, however, the communication session with the selected network path is not successful, as determined in decision block 918, a communication session is initiated with the non-selected network path in block 920. If the communication session is successfully established, as determined in decision block 922, the process returns to monitor the one or more parameters in block 902. If, however, the session is not successfully established, as determined in decision block 922, the user is notified that no networks are available in block 924 and process returns to monitor the one or more parameters in block 902.

If the communication session status is new, as determined in decision block 906 and the communication session is incoming, as determined in decision block 914, and the communication session is on the selected network path, as determined in decision block 926, the incoming communication is accepted via the selected network path in block 928 and process returns to monitor the one or more parameters in block 902. If, however, the communication session is not on the selected network path, as determined in decision block 926, the acceptance of the incoming communication session is delayed in block 930 and a transfer from the non-selected network path to the selected network path is initiated in block 932. If, the transfer is successful, as determined in decision block 934, the incoming communication is accepted via the selected network path in block 928 and process returns to monitor the one or more parameters in block 902. If, however, the transfer is not successful, as determined in decision block 934, the incoming communication is accepted via the non-selected network path in block 936 and process returns to monitor the one or more parameters in block 902. The method can be implemented using a computer program embodied on a computer readable medium wherein each step is performed by one or more code segments.

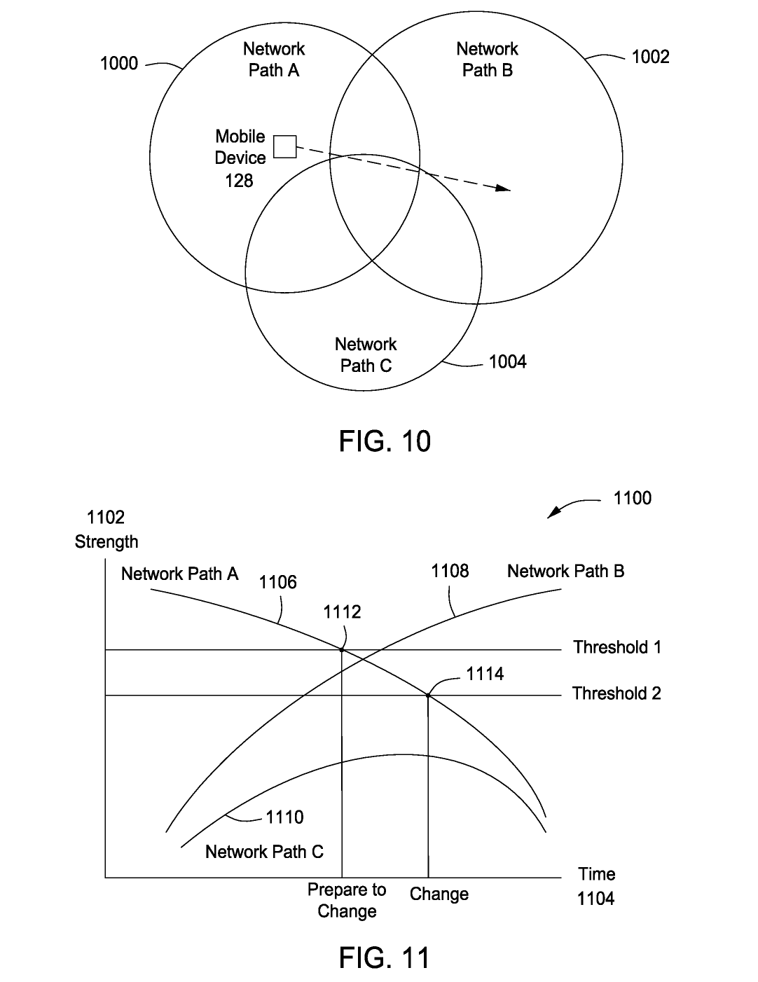

Referring now to FIG. 10, a block diagram of a mobile communications device moving between areas covered by network paths (e.g., A, B and C) of a wireless network in accordance with the present invention is shown. Also referring to FIG. 11, a graph 1100 of signal strength 1102 versus time 1104 for changing an association from one network path (e.g., A) to another (e.g., B) in accordance with one embodiment of the present invention is shown. The effective signal range of network paths A, B and C are represented by circles 1000, 1002 and 1004, respectively. Those skilled in the art will appreciate that these circles are artificial representations used to convey the operation of the present invention and that the actual coverage area of a network path dependants on many factors, does not have a well defined end and is rarely circular. As the mobile device 128 moves away from network path A, towards network path B and tangential to network path C, the strength of the signal 1106 from network path A decreases and the strength of signals 1108 and 1110 from network paths B and C, respectively, increases. At point 1112, the strength of the signal 1106 from network path A begins to drop below threshold one and the application within the mobile device 128 that monitors the network paths prepares to change to a new network path. Note that signal strength may be only one of many parameters that are monitored to determine whether a change to a new network path should be made. At point 1114, the strength of the signal 1106 from network path A begins to drop below threshold two and the application within the mobile device 128 that monitors the network paths changes to the new network path. The gap between threshold one and threshold two should be sufficient to minimize “ping-ponging” between network paths, prevent excessive preparations and use power efficiently.

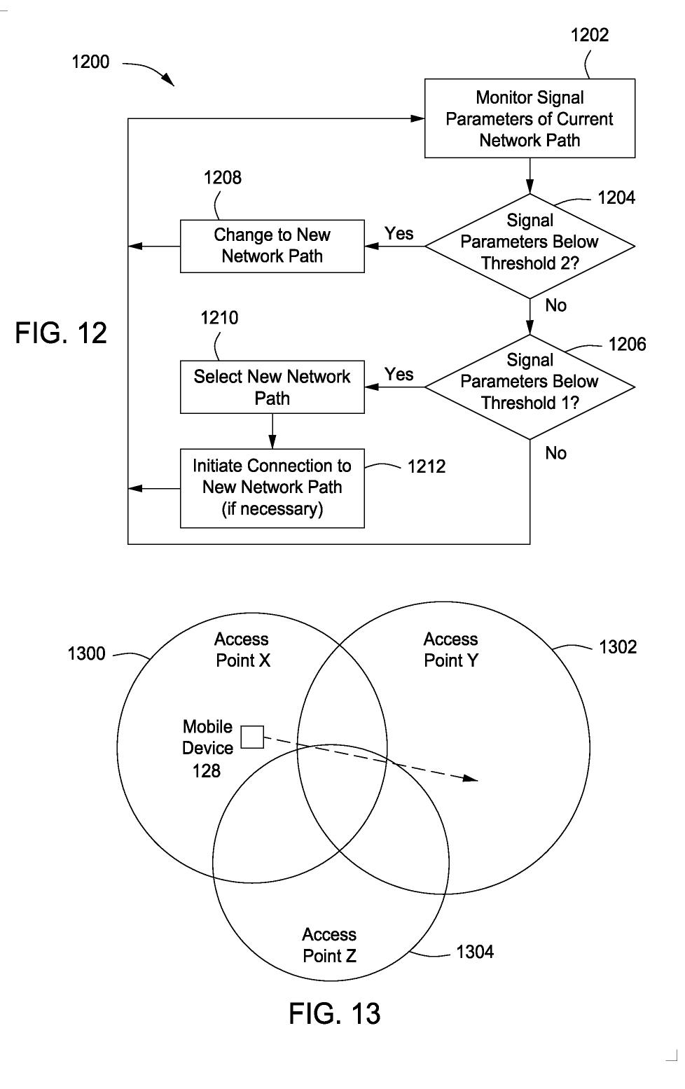

Now referring to FIG. 12, a flow chart of a network path selection process 1200 in accordance with another embodiment of the present invention is shown. A signal from one of the network paths is monitored in block 1202, which continues as long as one or more of the parameters (e.g., signal strength) does not fall below a second threshold, as determined in decision block 1204, or below a first threshold, as determined in decision block 1206. If the one or more of the parameters of the signal (e.g., signal strength) fall below the second threshold, as determined in decision block 1204, a change to the new network path is made in block 1208 and the process loops back to block 1202 to monitor the one or more parameters of the signal from the new network path. If the one or more parameters of the signal fall below the first threshold, as determined in decision block 1206, a new network path is selected in block 1210 and a connection to the new network path is initiated in block 1212 (if it does not already exist) and the process loops back to block 1202 to monitor the one or more parameters of the signal from the network path.

The present invention will not be described in reference FIGS. 13-17 to managing an association with one or more wireless network access points. Note that the mobile communications device 128 in FIG. 13-17 may or may not have a cellular module 142 (FIG. 1). As a result, these embodiments of the mobile communications device 128 do not have to be a dual mode communications device. One of the applications 112 (FIG. 1) monitors a signal from one of the access points, prepares to change to a new access point whenever one or more parameters of the signal fall below a first threshold, changes to the new access point whenever one or more parameters of the signal fall below a second threshold, and periodically performs a scan of the one or more access points wherein the scan comprises a short scan if a communication session is active and a complete scan otherwise. Note that all the methods discussed herein can be implemented using a computer program embodied on a computer readable medium wherein each step is preformed by one or more code segments.

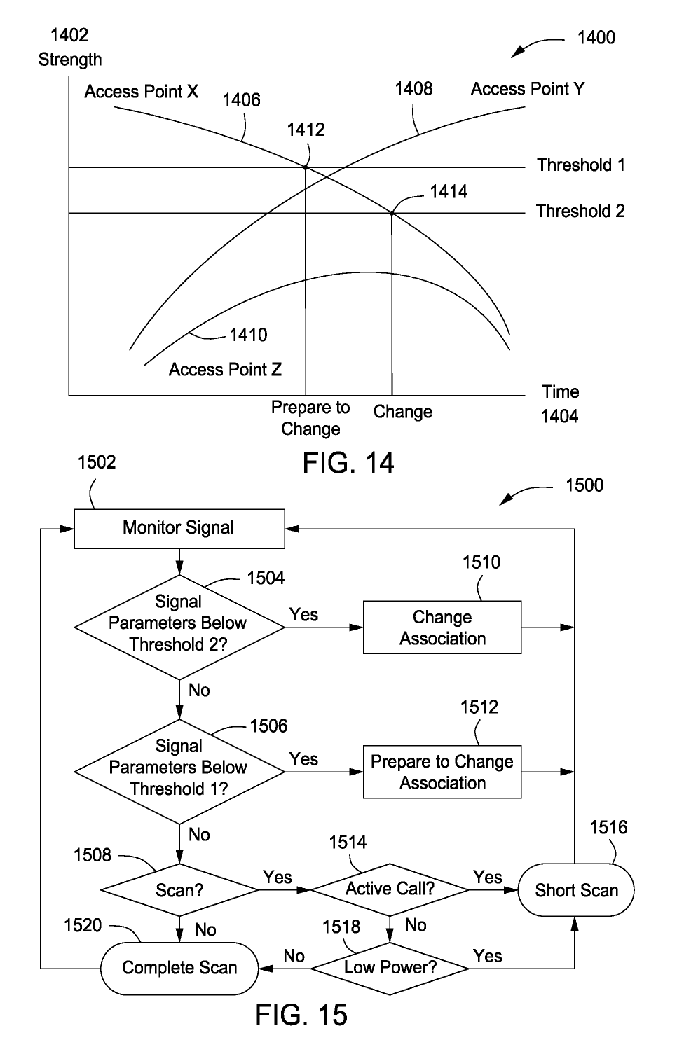

Referring now to FIG. 13, a block diagram of a mobile communications device 128 moving between areas covered by access points (e.g., X, Y and Z) of a wireless network in accordance with the present invention is shown. Also referring to FIG. 14, a graph 1400 of signal strength 1402 versus time 1404 for changing an association from one access point (e.g., X) to another (e.g., Y) in accordance with one embodiment of the present invention is shown. The effective signal range of access points X, Y and Z are represented by circles 1300, 1302 and 1304, respectively. Those skilled in the art will appreciate that these circles are artificial representations used to convey the operation of the present invention and that the actual coverage area of an access point dependants on many factors, does not have a well defined end and is rarely circular when the access point is located within a structure or between structures. As the mobile device 128 moves away from access point X, towards access point Y and tangential to access point Z, the strength of the signal 306 from access point X decreases and the strength of signals 1408 and 1410 from access points Y and Z, respectively, increases. At point 1412, the strength of the signal 1406 from access point X begins to drop below threshold one and the application within the mobile device 128 that monitors the access points prepares to change to a new access point. Note that signal strength may be only one of many parameters that are monitored to determine whether a change to a new access point should be made. For example, the one or more parameters may include signal strength, velocity, connection quality, data rate or a combination thereof. At point 1414, the strength of the signal 1406 from access point X begins to drop below threshold two and the application within the mobile device 128 that monitors the access points changes to the new access point. The gap between threshold one and threshold two should be sufficient to minimize “ping-ponging” between access points, prevent excessive preparations and use power efficiently.

Now referring to FIG. 15, a flow chart of a method 1500 of managing an association with one or more wireless access points in accordance with one embodiment of the present invention is shown. A signal from one of the access points is monitored in block 1502, which continues as long as one or more of the parameters (e.g., signal strength) does not fall below a second threshold, as determined in decision block 1504, or below a first threshold, as determined in decision block 1506, or it is time to perform a scan of one or more channels, as determined in decision block 1508. As previously described, the one or more parameters may include signal strength, velocity, connection quality, data rate or a combination thereof. Note that the currently monitored signal from the access point can be obtained by selecting the access point based on a short scan, complete scan, a sorted list of available channels or a combination thereof, and creating an association with the selected access point.

If the one or more of the parameters of the signal (e.g., signal strength) fall below the second threshold, as determined in decision block 1504, a change to the new access point is made in block 1510 and the process loops back to block 1502 to monitor the one or more parameters of the signal from the new access point. If the one or more parameters of the signal fall below the first threshold, as determined in decision block 1506, preparations are made to change to the new access point in block 1512 and the process loops back to block 1502 to monitor the one or more parameters of the signal from the access point. The preparations may include performing a short scan, selecting the new access point and creating an association with the new access point. If it is time to perform a scan of one or more channels, as determined in decision block 1508, and a communication session is active, as determined in decision block 1514, a short scan is performed in block 1516 and the process loops back to block 1502 to monitor the one or more parameters of the signal from the access point. If, however, a communication session is not active, as determined in decision block 1514, and the device is in a low power mode, as determined in decision block 1518, a short scan is performed in block 1516 and the process loops back to block 1502 to monitor the one or more parameters of the signal from the access point. If, however, the device is not in a low power mode, as determined in decision block 1518, a complete scan is performed in block 1520 and the process loops back to block 1502 to monitor the one or more parameters of the signal from the access point. Note that all the methods described herein can be implemented using a computer program embodied on a computer readable medium wherein each step is preformed by one or more code segments.

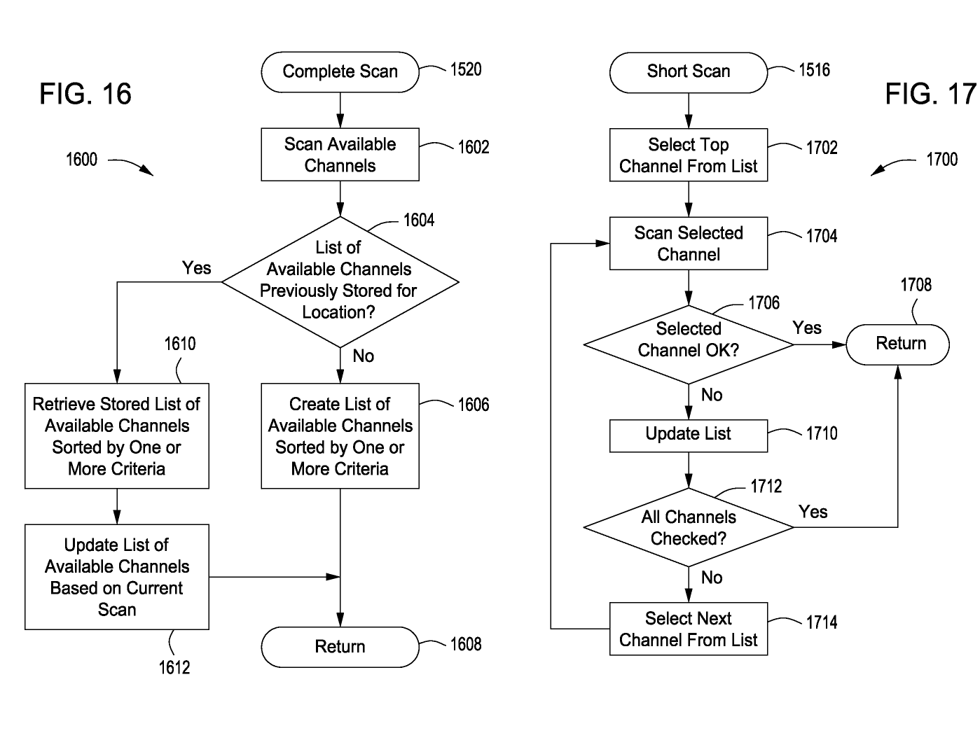

Referring now to FIG. 16, a flow chart of a method 1600 of performing a complete scan in accordance with one embodiment of the present invention is shown. The complete scan begins in block 1520 and a scan for all available channels is performed in block 1602. If a list of available channels has not been previously stored, as determined in decision block 1604, a list of available channels for the location sorted by one or more criteria is created and stored in memory in block 1606 and the process returns in block 1608. If, however, a list of available channels has been previously stored, as determined in decision block 1604, a stored list of available channels sorted by one or more criteria is retrieved in block 1610 and the list is adjusted or updated based on the current scan results and stored in memory in block 1612, and the process returns in block 1608. The one or more criteria may include operational information, performance information, location information, network information, historical information, quality of service information, security information, user information or a combination thereof. Note that multiple location or area dependant lists can be created and stored so that the mobile device 128 “learns” its surroundings, especially those in which it visits often. As a result, the mobile device 128 can intelligently select or pre-select from known available or potentially available channels based on the one or more criteria. In other words, the mobile device 128 can use preconfigured IP addresses based on the current location of the mobile device 128. Moreover, the mobile device 128 can adapt to new environments and changes to old environments. For example, the user can build his/her own list of access points to use that does not include all detectable access points while still allowing the mobile device 128 to detect and add new access points. The user can also prioritize the list.

Now referring to FIG. 17, a flow chart of a method 1700 of performing a short scan in accordance with one embodiment of the present invention is shown. The short or fast scan begins in block 1516 and a top or highest ranked channel based on one or more criteria is selected from the list of available channels in block 1702. The one or more criteria may include operational information, performance information, location information, network information, historical information, quality of service information, security information, user information or a combination thereof. The selected channel is scanned in block 1704, and if the scanned channel is OK (i.e., satisfies one or more parameters), as determined in decision block 1706, the process returns in block 1708. If, however, the scanned channel is not OK (i.e., does not satisfies one or more parameters), as determined in decision block 1706, the list is adjusted or updated with the scan results in block 1710. If all the channels from the list have been checked, as determined in decision block 1712, the process returns in block 1708. Alternatively, a complete scan can be performed before the process returns. If all the channels from the list have not been checked, as determined in decision block 1712, the next channel on the list is selected in block 1714, the newly selected channel is scanned in block 1704 and the process continues as previously described. Based on the foregoing, the short or fast scan provided by the present invention saves time, reduces power consumption and is not detectable to a user.

Although preferred embodiments of the present invention have been described in detail, it will be understood by those skilled in the art that various modifications can be made therein without departing from the spirit and scope of the invention as set forth in the appended claims.

What is claimed is:

1. A method for transferring a communication session between a first network path and a second network path using a mobile communications device, comprising the steps of:
monitoring one or more parameters associated with the first network path and the second network path using the mobile communications device;
selecting one of the network paths based on one or more criteria; and
transferring the communication session to the selected network path whenever the communication session is not using the selected network path.

2. The method as recited in claim 1, further comprising the steps of:
using the selected network path for new incoming and outgoing communication sessions; or
buffering the communication session during the transfer to the selected network path.

3. The method as recited in claim 1, wherein the communication session is a new incoming communication session and the step of transferring the communication session to the selected network path comprises the steps of:
delaying acceptance of the new incoming communication session via the non-selected network path;
transferring the new incoming communication session from the non-selected network path to the selected network path; and
accepting the new incoming communication session via the selected network path.

4. The method as recited in claim 3, further comprising the step of accepting the new incoming communication session via the non-selected network path whenever the selected network path is unavailable, the transfer is delayed or the transfer is unsuccessful.

5. The method as recited in claim 1, wherein the communication session is a new outgoing communication session and the step of using the selected network path comprises the steps of:
initiating the new outgoing communication session with the selected network path whenever the selected path is available; and
initiating the new outgoing communication session via the non-selected network path whenever the selected network path is unavailable, the initiation of the new outgoing communication session via the selected network path is delayed or the initiation of the new outgoing communication session via the selected network path is unsuccessful.

6. The method as recited in claim 1, wherein the step of transferring the communication session comprises sending a transfer request via the first network path, the second network path or a combination thereof.

7. A dual mode communications device comprising:
a VoIP module;
a RF module; and
an application communicably coupled to the VoIP module and the RF module, wherein the application monitors one or more parameters associated with the first network path and the second network path, selects one of the network paths based on one or more criteria and transfers the communication session to the selected network path whenever the communication session is not using the selected network path.

8. The dual mode communications device as recited in claim 7, wherein:
the one or more parameters comprise diagnostic information, operational information, performance information, location information, network information, network operator information, network path information, quality of service information, security information, signal strength, velocity, connection quality, voice quality, communications rate, packet loss, RF channel estimation, roaming speed or a combination thereof;
the one or more criteria comprise diagnostic information, operational information, performance information, location information, network information, network operator information, network path information, historical information, quality of service information, security information, communication session type, trigger events, user information or preferences, rate plans for the first and second network paths, estimated cost for the communication session, estimated costs for the transfer, minutes used, minutes available or a combination thereof;
the trigger events comprise the mobile communications device roaming between the first network path and the second network path, the communication session is dropped, successful association with an IP network, a user override, a drop in signal strength, communications rate or voice quality below a threshold value or a combination thereof;
the communication session comprises an existing communication session, a new incoming communication session or a new outgoing communication session; and
the first network path comprises a cellular network and the second network path comprises an IP network, or the first network path comprises the IP network and the second network path comprises the cellular network, or both network paths comprise different paths within the IP network, or both network paths comprise different paths within the cellular network.

9. The dual mode communications device as recited in claim 7, wherein:
the communication session transfer comprises a horizontal handover or a vertical handover;
the communication session is transferred without interruption, using a make-before-break process or transparently to a user of the communications device;
the selected network path is used for new incoming and outgoing communication sessions;
the communication session is only transferred if a minimum time period has elapsed since initiation of the communication session, a previous transfer or a combination thereof;
the application transfers the communication session by sending a transfer request via the first network path, the second network path or a combination thereof; or
the application buffers the communication session during the transfer to the selected network path.

10. The dual mode communications device as recited in claim 7, wherein:
the communication session is a new incoming communication session and the application transfers the new incoming communication session to the selected network path by delaying acceptance of the new incoming communication session via the non-selected network path, transferring the new incoming communication session from the non-selected network path to the selected network path and accepting the new incoming communication session via the selected network path;
the application accepts the new incoming communication session via the non-selected network path whenever the selected network path is unavailable, the transfer is delayed or the transfer is unsuccessful;
the communication session is a new outgoing communication session and the application initiates the new outgoing communication session with the selected network path whenever the selected network path is available, and initiates the new outgoing communication session via the non-selected network path whenever the selected network path is unavailable, the initiation of the new outgoing communication session via the selected network path is delayed or the initiation of the new outgoing communication session via the selected network path is unsuccessful; or
the application transfers the communication session by sending a transfer request via the first network path, the second network path or a combination thereof.

11. A method of managing an association with one or more wireless network access points, comprising the steps of:
monitoring a signal from one of the access points;
preparing to change to a new access point whenever one or more parameters of the signal fall below a first threshold;
changing to the new access point whenever one or more parameters of the signal fall below a second threshold; and
periodically performing a scan of at least one of the access points wherein the scan comprises a short scan if a communication session is active and a complete scan otherwise.

12. The method as recited in claim 11, wherein the step of preparing to change to the new access point comprises the steps of:
performing the short scan;
selecting the new access point; and
creating an association with the new access point.

13. The method as recited in claim 11, further comprising the steps of:
selecting an access point based on a short scan, a complete scan, a sorted list of available channels or a combination thereof; and
creating an association with the selected access point.

14. The method as recited in claim 11, wherein:
the short scan comprises the steps of selecting a channel from a list of available channels that are sorted based on one or more criteria, scanning the selected channel, and adjusting the list whenever the selected channel does not satisfy the one or more parameters; and
the complete scan comprises the steps of scanning for available channels, creating or adjusting the list of available channels sorted by one or more criteria, and storing the list of available channels in a memory.

15. The method as recited in claim 14, further comprising the steps of:
repeating the short scan for another channel; or
retrieving a different list based on a current location.

16. A communications device comprising:
a VoIP module; and
an application communicably coupled to the VoIP module, wherein the application monitors a signal from a wireless network access point, prepares to change to a new access point whenever one or more parameters of the signal fall below a first threshold, changes to the new access point whenever one or more parameters of the signal fall below a second threshold, and periodically performs a scan of one or more access points wherein the scan comprises a short scan if a communication session is active and a complete scan otherwise.

17. The communications device as recited in claim 16, further comprising a RF module communicably coupled to the application.

18. The communications device as recited in claim 16, wherein the application prepares to change to the new access point by performing the short scan, selecting the new access point and creating an association with the new access point.

19. The communications device as recited in claim 16, wherein the application further selects an access point based on a short scan, complete scan, a sorted list of available channels or a combination thereof, creates an association with the selected access point.

20. The communications device as recited in claim 16, wherein:
the one or more criteria comprise operational information, performance information, location information, network information, historical information, quality of service information, security information, user information or a combination thereof;
the one or more parameters comprise signal strength, velocity, connection quality, data rate or a combination thereof; and
the list comprises one or more location specific lists.

21. The communications device as recited in claim 16, wherein:
the short scan is also performed during a low power mode or when a communication session is active;
the short scan saves time, reduces power consumption, is not detectable to a user or a combination thereof;
the application performs the short scan by selecting a channel from a list of available channels that are sorted based on one or more criteria, scanning the selected channel and adjusting the list whenever the selected channel does not satisfy the one or more parameters;
the application performs the complete scan by scanning for available channels, creating or adjusting the list of available channels sorted by one or more criteria and storing the list of available channels in a memory; or
the application further repeats the short scan for another channel.

22. A communications device comprising:
a VoIP module; and
an application communicably coupled to the VoIP module, wherein the application selects a channel from a list of available channels that are sorted based on one or more criteria, scans the selected channel and adjusts the list whenever the selected channel does not satisfy one or more parameters.

23. The communications device as recited in claim 22, further comprising a RF module communicably coupled to the application.

24. The communications device as recited in claim 22, wherein:
the one or more criteria comprise operational information, performance information, location information, network information, historical information, quality of service information, security information, user information or a combination thereof;
the one or more parameters comprise signal strength, velocity, connection quality, data rate or a combination thereof;
the application further selects an access point based on the scan, a complete scan, a sorted list of available channels or a combination thereof, and creates an association with the selected access point;
wherein the scan is also performed during a low power mode or when a communication session is active; or
the application repeats the selection, scanning and adjusting steps for another channel.

25. The communications device as recited in claim 22, wherein:
the application further selects an access point based on the scan, a complete scan, a sorted list of available channels or a combination thereof, and creates an association with the selected access point; or
the application further retrieves a different list based on a current location.
